(19) United States
(12) Patent Application Publication
(10) Pub. No.: US 2012/0075052 A1
(43) Pub. Date: Mar. 29, 2012

(54) THERMAL TRIGGERING ELEMENT FOR A THERMALLY CONTROLLED SWITCHING ELEMENT

(76) Inventors: Hartmut Heuer, Bargeteheide (DE); Rudiger Klug, Ahrensburg (DE); Christopher Job, Praha (CZ)

(21) Appl. No.: 13/246,198

(22) Filed: Sep. 27, 2011

(30) Foreign Application Priority Data
Sep. 27, 2010 (DE) 202010013607.5

(51) Int. Cl. H01H 37/04

(52) U.S. Cl. 337/298

(57) ABSTRACT

A thermal triggering element for a thermal switching element in the form of a glass vial having an elongated shape, a completely enclosed interior space filled with a triggering liquid and including a gas bubble. The glass vial features along its longitudinal direction, positioned in a manner facing each other, a first longitudinal end with a tip emerging from a circumferentially running edge, in particular a circumferentially running thickened section, and a second longitudinal end with a rounded end. The vial is inserted as a thermal triggering element in the thermal switching element without the addition of fat or oil in the installation process. During the screwing-in of the abutment a significantly reduced torsion moment is applied to the glass vial, as compared to a conventional process without oil or fat. The glass vial is treated on at least the second longitudinal end in a friction-reducing manner.

### BACKGROUND OF THE INVENTION

1. Technical Field

The invention concerns a thermal triggering element for a thermally controlled switching element.

2. Background Information

Corresponding thermal triggering elements have been known for a long time in the form of glass bulbs, flasks, or glass vials, and are frequently used in different application areas. They are used for triggering temperature-controlled valves (as one form of a thermally controlled switching element) and, for that purpose, are usually clamped along their longitudinal extent between a valve closure body and an abutment and are loaded in the longitudinal direction with a certain closing force. If now the surrounding air warms beyond a triggering temperature, this in turn leads to an expansion of the triggering fluid in the interior space of the glass vial and—in the case of a force that exceeds the resistance of the glass material due to the pressure of the expanding triggering liquid—breaks the glass vial, so that the valve sealing member is released and the valve opens. A corresponding valve can, for example, be a stopper valve in a sprinkler system, such as it is used in buildings for fire protection purposes. Likewise the valve can however also be a safety valve of a gas tank, which is supposed to open in case of fire in order to release the gas contained in the gas tank in a controlled manner, and to therefore prevent a bursting of the tank and thereby an explosion. Alternatively the thermally controlled switching element can for example also be an electric switch that is held in an open or closed position by means of the thermal triggering element and against a switching force, and that is switched by the switching force (exerted for example by a spring), after the triggering of the thermal triggering element, into the respectively opposite position.

Corresponding thermal triggering elements are demonstrated and described in different implementation variants in, for example, EP 0 215 331 B1 in the form of elongated glass vials. How a glass vial is clamped between two abutments is also displayed there.

A thermal triggering element is also known from DE 2118790. The triggering element disclosed there has a first end with a tip, on which is deposited a thin sealing layer that is to consist of plastic, e.g. Teflon.

Additional examples for similar thermal triggering elements are provided in the publications GB 409,569 and U.S. Pat. No. 4,217,961. In EP 0 244 746 a method for the treatment of a glass vessel is described, in particular a glass ampule, as well as such a vessel itself, wherein the glass vessel that is disclosed there is not one that is intended for use as a thermal triggering element.

In practice the switching elements are pre-installed, wherein the glass vial is clamped in a position between a movable switching means, e.g. a sealing member of a valve, and the abutment in such a manner that the abutment section can be moved toward the switching means of the switching element and typically can be screwed-in against one of the longitudinal ends of the glass vial until a prescribed loading or clamping force is reached. The abutment element that can be screwed against the end of the glass vial is usually made of metal in that context, frequently of brass. While the abutment section is screwed in, it also rotates relative to the end of the glass vial and applies a torsional force thereby, which is undesired because it can modify the triggering behavior of the glass vial in an undesirable and usually unpredictable manner. The torsion applied hereby increases with increasing frictional coefficient between the material of the screwed-in abutment element and the material of the glass vial. This friction coefficient is usually comparably high between the materials that are typically used, glass and metal, usually brass.

For this reason one currently uses a trick in order to lower the friction coefficient correspondingly during the installation of the glass vial, where as part of the installation a drop of oil or a dosage of fat is applied to the longitudinal end of the glass vial, which comes in contact with the section of the abutment that can be screwed in. The dosing of fats or oils in automatic installation processes is however usually associated with problems in most cases, because of the possibility of drop formation as well as the dosing unit gumming up and getting dirty. In the worst case dust or dirt particles can be entrapped in such fat, then scratch against the glass of the glass vial during the installation of the abutment and cause marring of the surface, which in turn causes changes in the triggering characteristic. Furthermore such dosing installations that introduce the oil or fat into an automatic installation process are subject to frequent maintenance, which additionally increases the cost of this installation process. Dosing frequently also takes place in excess, which causes an increased usage of the oil or fat with, if nothing else, the associated negative impact on the environment.

### BRIEF SUMMARY OF THE INVENTION

It is the purpose of the invention to create a remedy here, by providing a possibility to use, without the addition of fat or oil in the installation process, improved glass vials as thermal triggering elements in the assembly of the thermal switching element, wherein during the screwing-in of the abutment a significantly reduced torsion moment is applied to the glass vial, as compared to a conventional process without oil or fat.

This problem is solved by means of a thermal triggering element for a thermal switching element.

The essential idea according to the invention is to treat an as such known thermal triggering element on at least the second longitudinal end, which is opposite the end with the tip, or even on both longitudinal ends with a friction-reducing treatment, which can consist for example of the deposition of a coating that adheres to the glass vial, or also of just a simple surface treatment, such as for example fire polishing. The thermal triggering element is consequently implemented in the form of a glass vial that features on a second of its two longitudinal ends a rounded end, to which the friction-reducing treatment is applied. This friction-reducing treatment, e.g. the application of the coating, correspondingly takes place not in connection with the installation process but occurs in particular already immediately after the manufacturing process of the thermal triggering elements (glass vials), before these are packaged and shipped for further processing, in particular for the pre-installation of the valve. Correspondingly certain requirements apply to the friction-reducing treatment: The result of this treatment has to in any case be so durable, in particular the applied coating has to in any case adhere to the glass vial so well that subsequent to the application of the coating it is able to withstand the further handling of the glass vial, in particular a packaging process, the unpacking as well as the transport until it is inserted into the valve between the sealing member and the abutment. In other words the thermal triggering element is in this case typically produced in a first production site where it is provided with the friction-lowering treatment, to be then packaged and shipped out. Due to the friction-reducing coating that adheres to the glass vial or a lowering of the friction coefficient that is achieved through a different friction-lowering treatment, such a thermal triggering element can now be integrated directly and without the previously necessary introduction of fat or oil into the thermal switching element, meaning be clamped between the switching means, e.g. the sealing member of a valve, and the abutment by means of the screwing-in of the abutment element with the ensuing application of a clamping force on the thermal triggering element. The torsional moment is reduced in this case at least by the value corresponding to the known process of greasing during the installation process (in this case reductions of typically approximately 30% are achieved), preferably even more, due to the treatment provided according to the invention, e.g. through an applied coating. In the case of thermal triggering elements that have been assembled and treated, in particular coated, according to the invention, reductions of the torsion moment can be verified in the range of between 30% up to 90% through friction reduction, depending on the selected treatment method and, in the case of applying a coating, also the coating material that is used. Coatings of, for example, wax, lacquers and foils have been shown to be the coating materials with the best friction-reducing properties, which leads to the highest reduction of the torsion moment.

In general it is recommended in the context of the selection of a coating, due to the previously discussed requirements regarding a certain resistance of the coating during packaging and the further handling of the thermal triggering element, to introduce the coating in the form of a solid phase, as it is the case with the already mentioned coating materials.

In order to minimize an effect on the triggering properties of the thermal triggering element as much as possible even after the assembly of the thermal switching element and the clamping of the thermal triggering element, on which the coating material remains, it is recommended to only apply the friction-lowering coating on the second longitudinal end of the glass vial and to reduce the area of the coating as much as possible to the area where the glass vial comes in contact with the element of the abutment, which moves and in particular is screwed-in toward said glass vial for the purpose of clamping and in which a possible torsion application takes therefore place. By these means one prevents that coating material that is possibly adhering elsewhere prevents a heat transfer through the glass vial into its interior and thereby delays a reaction time for the triggering of the thermal triggering element.

In a currently preferred variant the glass vial features on a first longitudinal end a circumferentially running thickened section and a tip that emerges therefrom, and has on its second longitudinal end a rounded, bulbous end, wherein the friction-lowering treatment has been applied preferably only limited to the rounded, bulbous end, e.g. a coating has only been applied there. Typically such a thermal triggering element is actually positioned with the sharp end, which is created during the closure of the interior space that is filled with the triggering liquid, pointing ahead against the switching means of the thermal switching element, e.g. against the sealing member of a valve (frequently subject to the interposition of a spring element for the absorption of the sealing force), and the abutment is screwed against the bulbous end of the thermal triggering element. The invention is however not limited to an implementation in connection with glass vials of the geometry described here, but can also be applied in the case of glass vials with the same diameter throughout (without thickened section). In that case the second longitudinal end is preferably and exclusively treated in a friction-lowering manner, e.g. coated or surface treated, such as fire polished, and it is that longitudinal end that in the installed position in a thermal switching element, e.g. a triggering valve, sits up against an abutment section.

A thermal triggering element according to the present invention can be obtained by dipping the glass vial with one of its longitudinal ends into a liquefied coating material and coating it by these means at that longitudinal end after the manufacture of the thermal triggering element in the form of a glass vial, which features an elongated shape with a completely enclosed interior space that is filled with a triggering fluid and includes a gas bubble. By these means finished glass vials can, for example, be clamped into an apparatus and be dipped, in batches, into a corresponding immersion bath with the selected area for coating, be pulled out with the adhering coating material and be cooled off until the coating, which preferably is at hand in a solid phase, solidifies. The thermal triggering elements that were coated in this manner can then be processed as usual, in particular be packaged for shipping and be shipped and unpacked as well as inserted for the assembly of thermal switching elements. Alternatively a glass vial can be surface treated on the already closed end, either prior to the filling with the triggering fluid or prior to the closing of the end that is still open for filling, meaning said glass vial is treated as a semi-finished product, for example by fire polishing in order to lower the friction coefficient. Such a treatment can however also take place on a completely filled and closed glass vial, so long as its triggering temperature is not exceeded.

To the extent that this is desired, adhering residuals of a coating can be removed from the thermal triggering element after the assembly, e.g. through heating below the triggering temperature in order to melt material with a correspondingly low melting temperature and to let it drip off. Such an approach is however usually not required because the coating is, according to the method according to the invention, applied preferably in a very limited location and is implemented only in the area of the thermal triggering element, against which the element of the abutment actually makes contact and to which a torsional force or a torsion moment is transferred.

### BRIEF DESCRIPTION OF THE DRAWINGS

Additional advantages and features of the invention are specified in the following description of an embodiment in reference to the enclosed drawings. It is thereby shown:

FIG. 1: a schematic representation of the side of the thermal triggering element according to the invention between the sealing member of a thermal switching element and an element of the abutment, which are respectively displayed in cross-section; and

FIG. 2: a similar representation as in FIG. 1 of a thermal triggering element according to the invention, disposed in a thermal valve, in this case a fire protection sprinkler.

### DETAILED DESCRIPTION OF THE INVENTION

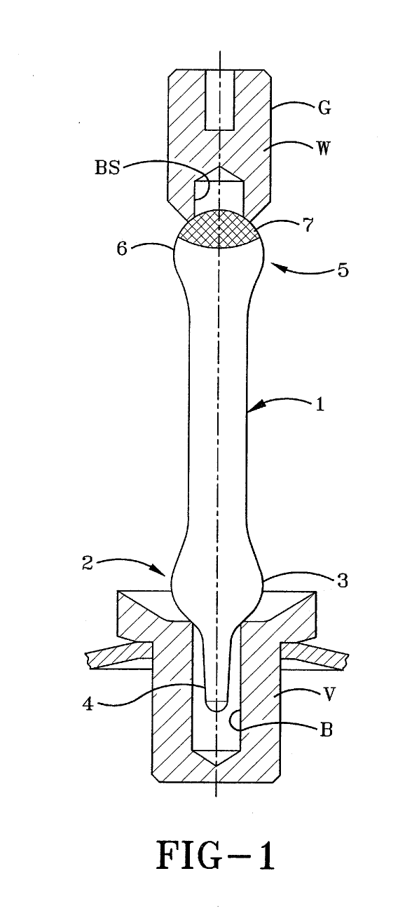

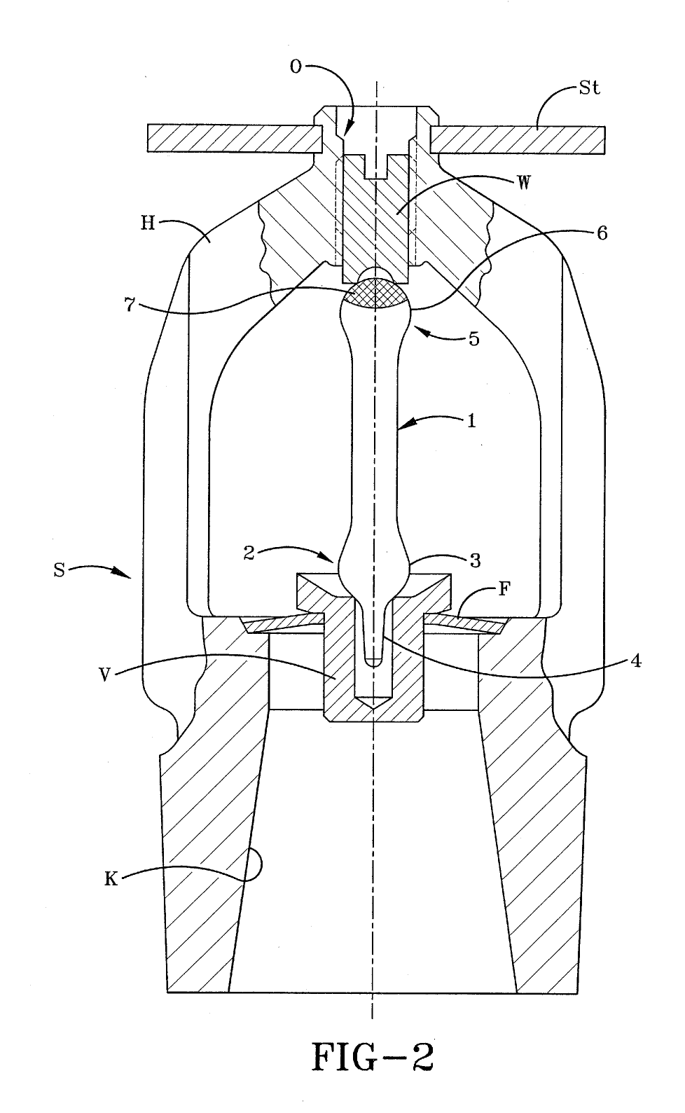

A thermal triggering element according to the invention is displayed in the figures in the form of a glass vial 1, wherein this glass vial 1 is displayed in FIG. 1 in an arrangement position between a sealing member V of a valve and an abutment W. In FIG. 2 the glass vial 1 is displayed fully in an arrangement in a valve, in this case in a sprinkler valve S.

The glass vial 1 exhibits an elongated form and encloses in its interior (here not shown) an elongated hollow space that extends essentially over the entire length of the glass vial 1 and that is filled with a triggering fluid and in which, besides the triggering fluid, a gas bubble is contained. The composition of the triggering fluid, its amount, the size of the gas bubble as well as the wall thickness of the glass vial 1 determine the factors that are important for the thermal triggering element, such as triggering temperature and triggering speed (delay), meaning the speed of the reaction to a temperature increase in the surrounding area.

The glass vial 1 features on a first longitudinal end 2 a circumferentially running, shoulder-like thickened section 3, from which a sharp end 4 extends. This sharp end 4 is created during the closing of the glass vial 1 by means of melting, after the filling with the triggering liquid.

The glass vial 1 features on its second longitudinal end 5, which is located opposite the first longitudinal end 2, a likewise thickened, bulbous end 6. On this longitudinal end 5, more precisely in the area of the bulbous end 6, the glass vial 1 is provided, by means according to the invention, with a coating 7 that is indicated here by hatching and that consists in a solid phase of a friction-lowering material. Depending on the selected coating material a matching application method is used, e.g. immersion, gluing, spraying. Preferably this coating consists of a wax, a lacquer, a foil. A surface treatment for friction reduction, e.g. fire polishing, can also be performed instead of applying a coating in the area 7.

In FIG. 1 it is already schematically represented how the glass vial 1 is clamped in its longitudinal direction in a valve between a sealing member V and an abutment W in a state of assembly, wherein in this example the glass vial 1 is fixed with its first longitudinal end 2 at the sealing member V because the sharp end protrudes into a blind bore hole B and the glass vial abuts with the thickened section 2 against the edge of the blind bore hold B, and abuts with its second longitudinal end 5, more precisely with the bulbous end 6, against a further blind bore hole BS in the abutment.

One recognizes here that the coating 7 is implemented on the glass vial 1 in such a manner that it covers the area in which the glass vial 1 abuts with its bulbous end 6 against the section that surrounds the opening of the blind bore hold BS in the abutment W. It is thereby assured that during the immobilization of the glass vial 1, during which the abutment W, which is essentially shaped like a cylinder and features a thread G on its surface area, is screwed into a corresponding counter thread and is tightened in the longitudinal direction of the glass vial 1 for the purpose of clamping it, the abutment W glides across the bulbous end 6 of the glass vial 1 due to the friction-reducing coating 7 that is applied there. A torsion moment that is applied to the glass vial 1 by these means during the screwing-in of the abutment and the clamping of the glass vial 1 with the required holding force is significantly reduced; depending on the coating material used by 30% up to 90%.

For the purposes of better clarification FIG. 2 displays again how a glass vial 1 is inserted into a sprinkler valve S.

One recognizes again the previously described seat of the glass vial 1 between the sealing member V and the abutment W. The sealing member V in this case serves the purpose of closing a water channel K, in which water is standing if the sprinkler valve S is deployed and holding discharge pressure. The sealing member V is linked in a sealing manner with a spring F that in turn abuts against a step on the discharge side of the water channel K. The purpose of this spring is to absorb the closing force with which the glass vial 1 is clamped into the seat, as displayed in FIG. 2; in addition it permits the compensation of length variations of the glass vial 1 or the sealing member V or the abutment W due to temperature variations.

The sprinkler valve S is provided with retaining straps H that form a dome-shaped opening between each other, into which the glass vial 1 is inserted. The retaining straps H end in a threaded opening O into which the abutment W is screwed with its outer thread, by means of which it can be moved in the longitudinal direction of the glass vial 1 toward the same. A distribution star St is disposed around the thread opening O and fans out the water that emerges from the water channel K in a case of activation in a known manner, in order to achieve a broad surface coverage effect for the fire extinguishing effort.

In this illustration too one can again clearly recognize how the coating 7 on the bulbous end 6 of the glass vial 1 acts together with the abutment W in order to lower the friction and thereby the transfer of a torsion moment during the screwing-in of the abutment W and the clamping of the glass vial 1.

It becomes clear to the person skilled in the art that the application of a glass vial 1 for a sprinkler valve S that is displayed in FIG. 2 is not the only possible application. Likewise the glass vial 1 can, for example, be also used in thermally triggering release valves on pressurized gas tanks or in comparable applications where a thermally controlled trigger of a valve is required.

### LIST OF REFERENCE SYMBOLS

1 Glass vial
2 Longitudinal end
3 Thickened section
4 Sharp end
5 Longitudinal end
6 bulbous end
7 Coating
B Blind bore hole
BS Blind bore hole
F Spring
G Thread
H Holding strap
K Water channel
O Thread opening
S Sprinkler valve
ST Distribution star
V Sealing member
W Abutment

1. A thermal triggering element for a thermal switching element comprising a glass vial that features an elongated shape, with a completely enclosed interior space that is filled with a triggering liquid and includes a gas bubble, wherein the glass vial features along its longitudinal direction, positioned in a manner facing each other, a first longitudinal end with a tip that emerges from a circumferentially running edge, in particular a circumferentially running thickened section, and a second longitudinal end with a rounded end, and wherein the glass vial has been treated in a friction-lowering manner on at least the second longitudinal end.

2. The thermal triggering element according to claim 1, wherein the friction-lowering treatment takes place only in the area of the second longitudinal end of the glass vial.

3. The thermal triggering element according to claim 1, wherein the friction-reducing treatment is a surface treatment.

4. The thermal triggering element according to claim 1, wherein the friction-reducing treatment is the application of a friction-lowering coating that adheres to the glass vial.

5. The thermal triggering element according to claim 4, wherein the friction-lowering coating exhibits a solid phase.

6. The thermal triggering element according to claim 4, wherein the friction-lowering coating is made of wax, lacquer, or a foil.

7. The thermal triggering element according t claim 3, wherein the surface treatment is a fire polishing treatment.

8. A thermal triggering element for a thermal switching element comprising:
a glass vial having an elongated shape which extends longitudinally; said vial having a first longitudinal end and a second longitudinal end;
a completely enclosed interior space defined in the glass vial;
a triggering liquid disposed in the interior space;
a gas bubble disposed within the triggering liquid; and wherein at least one of the first and second ends of the glass vial is treated in a friction-lowering manner.

9. The thermal triggering element as defined in claim 8, wherein the friction-lowering treatment comprises the application of a wax, a lacquer or a foil or a fire-polishing treatment.

10. The thermal triggering element as defined in claim 8, wherein the first longitudinal end of the glass via includes a tip that emerges from a circumferentially running edge, and the second longitudinal end is rounded.

11. The thermal triggering element as defined in claim 10, wherein the friction-lowering treatment is applied to the second end of the glass vial.

12. The thermal triggering element as defined in claim 11, wherein the friction-lowering treatment is additionally applied to the first end of the glass vial.
